(19) United States
(12) Patent Application Publication
(10) Pub. No.: US 2011/0102786 A1
(43) Pub. Date: May 5, 2011

(54) Method of Determining the Spatial Configuration of Molecules in Particles or Macromolecules, Especially for Determining the Shape of Metal Nanoparticles and Device for the Implementation Thereof

(75) Inventors: Guillaume Bachelier, Villeurbanne (FR); Emmanuel Benichou, Beligneux (FR); Guillaume Revillod, Annemasse (FR); Isabelle Russier-Antoine, Lyon (FR); Julien Duboisset, Lyon (FR); Pierre-Francois Brevet, Beligneux (FR); Christian Jonin, Mions (FR)

(73) Assignees: UNIVERSITE CLAUDE BERNARD LYON I, Villeurbanne (FR); CENTRE NATIONAL DE LA RECHERCHE SCIENTIFIQUE, Paris (FR)

(21) Appl. No.: 12/936,019

(22) PCT Filed: Mar. 30, 2009
(86) PCT No.: PCT/FR09/50529

§ 371 Date: Dec. 10, 2010

(30) Foreign Application Priority Data
Apr. 4, 2008 (FR) 0852286

(51) Int. Cl. G01J 3/00

(52) U.S. Cl. 356/300

(57) ABSTRACT

The present invention relates to a method and a device for determining the spatial configuration of molecules in particles or macromolecules or the shape of nanometric metallic particles. This method provides for the excitation of said particles or macromolecules placed in solution by way of two pulsed laser beams (E1, E2) that are identical but of different incidence I1, I2 with respect to the tested particles and then the detection of the photons of second-harmonic light (SHG) and the establishment of diagrams of polarization-resolved Hyper-Rayleigh scattering (HRS) intensity for each of the excitation beams. On the basis of each HRS diagram thus determined, a parameter η_{E1}, η_{E2} is calculated for each beam, said parameter being characteristic of the spatial configuration of the molecules within the particles tested, which is determined by transferring the parameters calculated into a previously constructed diagram η_{E2}=f(η_{E1}).

The present invention relates to a method and a device for determining the spatial configuration of molecules in particles or macromolecules. This method and this device are in particular suited to the determination of the shape of nanometric metallic particles.

More particularly, the present invention proposes a method and a device allowing the characterization of the spatial configuration of molecules or macromolecules and in particular of the shape of nanometric metallic particles on the basis of their non-linear optical response to luminous excitation of large peak power established by a laser for example.

The method of the invention is in particular based on the utilization of measurements of the Hyper-Rayleigh Scattering intensity, or HRS intensity, so as to extract from these intensities information about the spatial configuration of various assemblages of molecules and in particular of the shape of nanometric metallic particles.

Various procedures for characterizing particles have already been known for a few years, the main ones being:
granulometry, inexpensive but which gives only rudimentary indications about the size of the particles;
absorption spectrometry, but which gives only information about the composition of the particles in the absence of calibration and of strict constraints;
electron microscopy, which remains a lengthy and expensive examination and poses a big problem of representativity of the sample in statistical terms.

These procedures do not make it possible to simply characterize the organization of molecular arrangements or of macromolecules on the micrometric or nanometric scale or the shape of nanometric metallic particles, with the exception perhaps of electron microscopy.

Recently, a number of scientists and industrial researchers have begun to explore the route of non-linear optical phenomena as a means for characterizing the shape of particles and macromolecules, as well as their changes.

More particularly, European patent application EP 1576394 A2 describes a procedure for detecting conformational changes within molecules in real time which is based on the generation and measurement of intensity of second-harmonic or third-harmonic light beams (SHG or THG for Second Harmonic Generation or Third Harmonic Generation).

However, this procedure does not make it possible to provide information about the exact molecular organization, at a given instant t, of an arrangement of molecules or the shape of a nanometric metallic particle.

Spectroscopic procedures implementing third-order non-linear phenomena have been experimented with, as in document US 2006/063188 A1 for retrieving the geometry of molecules in solution. However these procedures, based on the observation of vibratory phenomena at the electron level of the molecules and atoms constituting them, are unwieldy and expensive.

The aim of the present invention is to provide a method which makes it possible to determine and to characterize at a given instant the geometry and the spatial conformation of the molecules within an arrangement of molecules, in particular so as to characterize the shape of a nanometric metallic particle.

Another aim of the invention is to provide a method such as envisaged hereinabove which is simple to implement and to utilize and which gives faithful and reproducible results.

Another aim of the invention is to provide a device for the implementation of the aforementioned method and whose production and cost of utilization are viable from the industrial standpoint.

These various aims are achieved according to a first subject of the invention by virtue of a method for determining the spatial configuration of molecules in particles or macromolecules or the shape of a nanometric metallic particle, according to which:
at least one particle or macromolecule whose shape or molecular organization it is desired to ascertain is placed in solution,
the particle or particles or macromolecules placed in solution is or are excited by way of at least two polarized excitation light beams propagating and penetrating the solution along two distinct directions of incidence,
the photons of light scattered by at least one excited particle or macromolecule present in the solution are detected by non-linear optics;
for each excitation beam, the polarization-resolved Hyper Rayleigh scattering (HRS) intensity of the detected photons of scattered light is determined,
a diagram η_{E2}=f(η_{E1}) is established, where η_{E1} and η_{E2} are respectively two parameters characteristic of the molecular organization within an assemblage of molecules or of the shape of a nanometric metallic particle having a non-linear response and defined respectively by the following relations:

$${η}_{E 1} = \frac{{a}_{E 1} + {c}_{E 1}}{{b}_{E 1}} and {η}_{E 2} = \frac{( {a}_{E 1} - {a}_{E 2} ) + ( {c}_{E 1} - {c}_{E 2} )}{( {b}_{E 1} - {b}_{E 2} )} ,$$

where a, b, c are the absolute values of the HRS scattering intensity at three distinct angles of polarization of each excitation beam

and with:

a_{E1}=a_{d}+a_{q} and a_{E2}=a_{d};

b_{E1}=b_{d}+b_{q} and b_{E2}=b_{d};

c_{E1}=c_{d}+c_{q} and c_{E2}=c_{d};

the indices d and q indicating respectively a dipolar and quadripolar component of the HRS intensity values a, b, c for each excitation beam, these various components being defined by the following mathematical relations:

$$\begin{matrix}{a}_{d} = G 〈 {β}_{XXX} β {*}_{XXX} 〉 \\ {b}_{d} = G 〈 4 {β}_{XXX} β {*}_{XXY} + 2 {β}_{XXX} β {*}_{XYY} 〉 \\ {c}_{d} = G 〈 {β}_{XYY} β {*}_{XYY} 〉 \\ {a}_{q} = {G ( Δ k )}^{2} {a}^{2} 〈 [ {Γ}_{L , ZXXX} + {Γ}_{L , YXXX} ] [ Γ {*}_{L , ZXXX} + Γ {*}_{L , YXXX} ] 〉 \\ {b}_{q} = {G ( Δ k )}^{2} {a}^{2} 〈 \begin{matrix}[ {Γ}_{L , ZXXX} + {Γ}_{L , YXXX} ] [ Γ {*}_{L , ZXXX} + Γ {*}_{L , YXXX} ] + \\ [ {Γ}_{L , ZXYY} + {Γ}_{L , YXYY} ] [ Γ {*}_{L , ZXXX} + Γ {*}_{L , YXXX} ] + \\ [ {Γ}_{L , ZXXY} + {Γ}_{L , YXXX} ] [ Γ {*}_{L , ZXYY} + Γ {*}_{L , YXYY} ]\end{matrix} 〉 \\ {c}_{q} = {G ( Δ k )}^{2} {a}^{2} 〈 [ {Γ}_{L , ZXYY} + Γ {*}_{L , YXYY} ] [ Γ {*}_{L , ZXYY} + Γ {*}_{L , YXYY} ] ;\end{matrix}$$

with:

G which is a constant,

β, Γ two tensors and β*, Γ* their complex conjugate tensors,

(Δk)² the square differential of the wave vectors 2k of the wave vector 2k of the fundamental and of K the wave vector of the harmonic, and

a the size of the particle or macroparticle;
for each previously determined HRS scattering intensity the two parameters η_{E1} and η_{E2} are calculated for the particle or macromolecule under study and
from this is deduced the geometric configuration of the molecules in the particle or macromolecule by transferring these two parameters onto the previously established graph η_{E2}=f(η_{E1}).

The method of the present invention exhibits the advantage of allowing the direct determination of the shape of the particles and of the spatial configuration of molecules within aggregates or of macromolecules on the basis of the measurement of the HRS intensity transmitted by these particles or macromolecules placed in solution, without other treatment or transformation of the tested samples. The method operates whatever the nature of the solution in which the samples are placed, as long as they are transparent to the wavelengths of the light beams used.

Moreover, the method of the present invention provides good statistical representativity, as well as very high sensitivity to defects (being considered to be defects are the deviations to the organizations or shapes exhibiting a center of inversion) of the tested samples, in particular in comparison with a reading by electron microscopy in particular.

Finally, the implementation of the method of the invention is very simple, and it may be easily automated and rendered compact so as to render it utilizable from an industrial standpoint.

In accordance with a first preferred characteristic of the method of the invention, the detection of the photons of light scattered by at least one excited particle or macromolecule in solution is carried out along a direction forming an angle α with the direction of incidence of a first excitation light beam and forming an angle β with the direction of incidence of the second excitation light beam in the solution containing the particles or macromolecules under study, α being different from β and greater than zero.

Preferably, the excitation of the particles or macromolecules in solution is carried out by at least two polarized light beams of coherent light, such as for example two polarized laser beams, and again preferably two excitation beams whose directions of incidence with respect to the solution containing the samples are perpendicular to one another.

In accordance with another preferred characteristic of the method of the invention, the two excitation light beams are emitted by at least one coherent light source of laser type, in particular a laser of nanosecond or femtosecond type.

Moreover, in accordance with another characteristic of the method of the invention, the polarization of each excitation light beam is rotated according to at least three distinct angles of polarization during each phase of illuminating and exciting the particles or macromolecules in solution.

Finally, still according to the method of the invention, the direction of detection of the photons of light scattered by the particles or macromolecules under study is chosen to be the same as the direction of incidence of at least one of the two excitation light beams in the solution containing the particles or macromolecules.

In accordance with what was set forth above, another subject of the invention also resides in the provision of a particular device adapted for the implementation of the method of the invention. This device comprises:
means for producing at least two beams of coherent light,
means for polarizing at least two beams of coherent light,
at least one vessel or cell able to contain at least one particle or macromolecule placed in solution, the vessel or cell consisting of a material transparent to the two beams of coherent light so as to allow the excitation, by these two beams, of at least one particle or macromolecule in solution placed in the vessel or cell,
means for orienting the two beams of coherent light along two distinct directions of incidence with respect to the vessel or cell,
means for detecting photons of light scattered by at least one particle or macromolecule in solution present in the vessel or cell and excited by the two beams of coherent light polarized by the polarizing means,
means for calculating the Hyper-Rayleigh scattering intensity (HRS intensity) detected by the means for detecting and calculating and establishing the diagram η_{E1}=f(η_{E2}) defined by the method of the invention.

Various preferred characteristics of the device of the invention also provide that:
the means for producing the two beams of coherent light comprise at least one coherent light source and means for dividing a single beam emitted by this source into two distinct light beams;
the means for orienting the light beams along two distinct directions of incidence with respect to the vessel or cell comprise reflecting and/or semi-reflecting mirrors;
the vessel or cell consists of a material transparent to the wavelengths λ and λ/2 of the at least two excitation beams;
the coherent light source is a source of nanosecond or femtosecond laser type.

Other characteristics and advantages of the method and of the device of the present invention will emerge on reading the detailed description which will follow, made with reference to the appended figures among which:

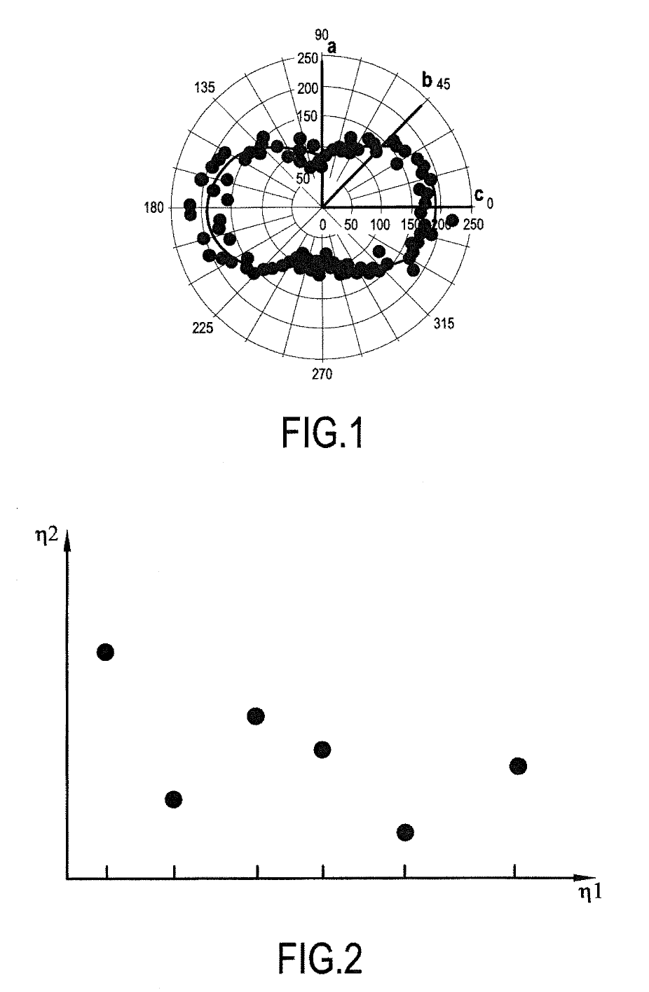

FIG. 1 represents a diagram of Hyper-Rayleigh scattering (HRS) intensity in polar coordinates on which has been schematically represented the decomposition into Cartesian coordinates of the values of HRS intensities according to 3 distinct angles of polarization so as to obtain the values of parameters a, b, c useful for the calculation of the parameters η₁ and η₂ according to the method of the invention;

FIG. 2 represents an exemplary diagram η₂=f(η₁) calculated theoretically and used to determine the spatial configuration of a non-centrosymmetric arrangement of molecules or the shape of nanometric particles according to the method of the invention;

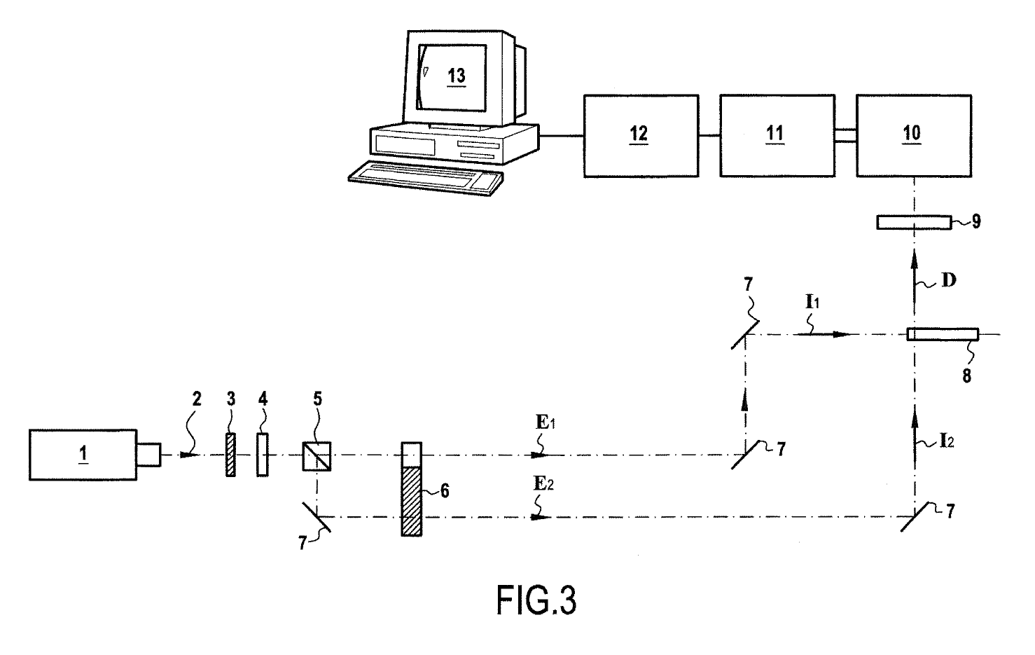

FIG. 3 represents an exemplary device for the implementation of the method of the invention;

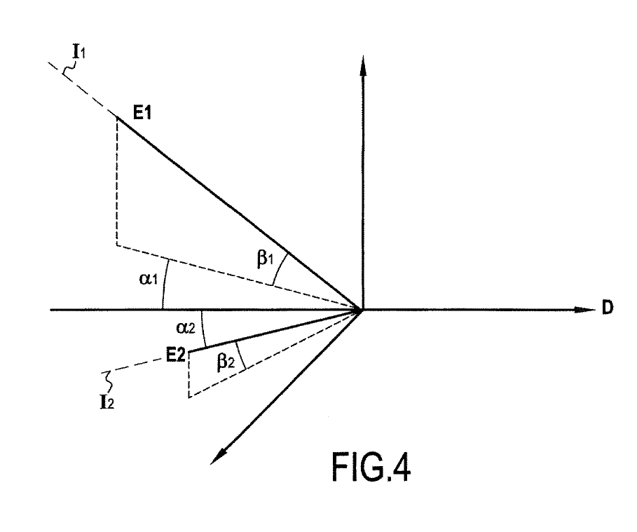

FIG. 4 represents a diagram representative of the directions of the excitation beams according to the method of the invention.

The present invention proposes a method for determining and characterizing the spatial configuration of molecules within a molecular arrangement or the shape of nanometric metallic particles.

This method is based on an optical procedure comprising in a simplified manner:
on the one hand an excitation of particles or macromolecules that it is desired to test placed in solution with the aid of two beams of coherent light of very high power and polarized, and
on the other hand a detection of the non-linear optical response emitted by the excited particles or macromolecules and a processing of this response so as to extract therefrom information about the conformation of the molecular arrangement within these macromolecules or about the shape of nanometric metallic particles.

More precisely, the method of the invention consists in exciting said particles or macromolecules placed in solution with the aid of two pulsed and polarized laser beams E1, E2 of different incidence and in collecting and detecting the photons of second-harmonic light that are generated by the interaction of each excitation beam E1, E2 with the particles in solution. On the basis of the detection of these photons of second-harmonic light, the method of the invention proposes to plot a polarization-resolved Hyper-Rayleigh scattering (HRS) intensity diagram such as represented for example in FIG. 1 for the non-linear optical response emitted by particles or macromolecules placed in solution under the excitation of each beam E1, E2.

Thus, two polarization-resolved HRS intensity diagrams are plotted, one for each laser excitation beam. Thereafter, on the basis of each HRS diagram, a parameter η characteristic of the spatial configuration of a molecular arrangement or of a shape of metallic particle is calculated and is placed on a diagram η_{E2}=f(η_{E1}) such as represented in FIG. 2, previously established in a theoretical manner as will be set forth subsequently.

This diagram η_{E2}=f(η_{E1}) establishes a cluster of points which each correspond to a given molecular arrangement or a given shape such as for example tetrahedral, anteprism, cube etc. The parameters η_{E1} and η_{E2} correspond to the theoretical values of the parameter η as a function of:
the incidence of the laser excitation beam considered with respect to the solution containing the tested particles,
of a given molecular arrangement or of a shape given,
of the polarization of the laser excitation beam considered.

Thus, by transferring the parameter η calculated on the basis of the HRS diagrams plotted on the basis of the measurements performed on the tested samples it is possible to determine the molecular arrangement or the shape of the tested particles.

The method of the invention will subsequently be described in detail in a preferred exemplary implementation and with the aid of a device specially designed for the latter and such as represented in FIG. 3.

The device of the invention comprises first of all means for producing at least two beams of coherent light E1, E2 consisting in the exemplary embodiment presented of a laser source 1 and a splitter plate 5.

The laser source 1 is in particular preferably a source of nanosecond or femtosecond laser type. This source 1 emits a laser beam 2 whose wavelength λ lies in the near infra-red, and preferably between 800 and 1100 nm. The laser beam 2 encounters the splitter plate 5 placed on the optical axis of emission of the source 1 so as to divide the laser beam 2 into two identical excitation beams E1 and E2.

It is also possible to generate the two excitation laser beams E1, E2 on the basis of two independent laser sources; however this solution exhibits the drawback of its very significant cost and of a potential lack of homogeneity and of coherence between the two beams thus generated.

Between the source 1 and the splitter plate 5 are disposed a filter 3 so as to render the incident beams perfectly monochromatic and polarizing means formed for example by a half-wave plate 4. These polarizing means provide a determined polarization of the laser beam 2 before its division at the level of the splitter plate 5, this polarization possibly being modified continuously so as to rotate according to at least three distinct angles of polarization of the beams E1 and E2 during the phases of illuminating the tested samples whose spatial configuration or shape it is desired to determine according to the method of the invention.

On exiting the splitter plate 5, the two excitation beams E1, E2 are respectively guided by reflecting or semi-reflecting mirrors 7 toward a vessel or cell 8 able to contain at least one particle or macromolecule placed in solution.

This vessel or cell 8 advantageously consists of a material transparent to the two excitation laser beams E1, E2 at their wavelength λ as well as at their half-wavelength λ/2 so as to allow the excitation, by these two beams, of at least one particle or macromolecule in solution placed in the vessel 8. This aqueous or organic solution must not influence the non-linear optical response of the particles or macromolecules placed in it to the excitation of the beams E1, E2. If appropriate, its contribution may be subtracted by a measurement carried out in the absence of the particles or macromolecules.

The mirrors 7 are preferably positioned in a manner adapted for orienting the two excitation beams E1, E2 toward the vessel 8 along two non-colinear directions of incidence I1, I2, and preferably perpendicular to one another. Thus guided, the two beams E1, E2 penetrate the vessel 8 and the solution contained inside and encounter at least one particle or macromolecule bathing in said solution and whose geometric configuration it is desired to ascertain.

This particle or macromolecule is then subjected to the very high luminous power of the beams E1, E2 and then emits photons, or in all strictness at least one so-called second harmonic generation photon, whose wavelength is equal to half the fundamental wavelength λ of the beams E1, E2.

This or these second harmonic generation photon(s) provides(provide) information, once detected and their response appropriately processed by non-linear optics, about the deviation in geometry of the particle with respect to a perfect sphere as has been described for example in the document entitled “electric dipole origin of the second harmonic generation of small metallic particles”, published in the journal Physical Review B 71, 165407 (2005), J. Nappa, G. Revillod, I. Russier-Antoine, E. Benichou, C. Jonin, P. F. Brevet.

However in this article, the excitation of the particles is carried out along only one direction of incidence, with a single beam, this not making it possible to exactly characterize the exact shape of the particles or the spatial conformation of molecules within the macromolecules.

On the other hand, the method of the present invention proposes in a novel and inventive manner to carry out an excitation of the particles tested along two preferably but not necessarily perpendicular directions of incidence I1, I2, with the aid of two, preferably linearly, polarized excitation laser beams E1, E2 and the polarization of which is furthermore rotated during each phase of illuminating and exciting the particles or macromolecules in solution. This illumination is preferably carried out according to only three distinct angles of linear polarization. It should be noted here however that a greater number of angles of polarization improves the results. This series of measurements of the intensity as a function of polarization angle makes it possible to plot a diagram such as represented in FIG. 1, the fitting of which by a simple mathematical function makes it possible to obtain coefficients a, b, c which will be presented subsequently.

In order to allow detection and accurate measurement of the photons of second-harmonic light that are generated by the particles or macromolecules tested during the implementation of the method of the invention, the device also comprises an optical chopper 6 which enables each of the excitation beams E1, E2 to be allowed through alternately to the test vessel 8 containing the tested particles in solution.

This optical chopper 6 thus makes it possible to limit any disturbance due to possible interference between the two beams E1, E2 at the level of the particles in the vessel 8 if the two beams E1, E2 were projected simultaneously toward the vessel. It is thus possible to detect only the signals of non-linear response of the tested particles corresponding exactly to each of the two luminous excitations, for better utilization of the results thereafter.

To accurately detect the non-linear response of the tested particles placed in solution in the vessel 8, the device of the invention comprises means for detecting light photons scattered by second harmonic generation (SHG) by at least one particle or macromolecule in solution present in the vessel 8 and excited by the beams E1, E2.

These means of detection firstly comprise an analyzer 9 composed of a lens for collecting the scattered light exiting the vessel 8, a half-wave plate λ/2 for selecting the wavelength corresponding to the second-harmonic light and a polarizer cube, this device in series making it possible to take account of the biases of the spectrometer grating in relation to a particular selected polarization.

The detection means, and in particular the analyzer 9, are placed in such a way that the detection is carried out along a direction D forming an angle α with the direction of incidence I1 of a first excitation light beam and forming an angle β with the direction of incidence I2 of the second excitation light beam in the solution containing the particles or macromolecules under study, α being different from β and greater than zero, as represented in FIG. 4.

Preferably, in order to simplify the utilization of the measurements, the direction of detection D is made the same as the direction of incidence I1, I2 of one of the excitation beams E1, E2, such as for example in the direction I2 in the embodiment represented in FIG. 3.

Behind the analyzer 9, the means of detection comprise, placed in series, a spectrometer 10, a photomultiplier 11 and a photon counter 12.

As a variant, the photomultiplier 11 can also be replaced with a CCD camera or an avalanche photodiode for example. In the case of a CCD camera, the photon counter 12 becomes superfluous and may be removed from the setup but a data processing computer routine will have to be added in order to extract the intensity measured at λ/2.

These detection means 9, 10, 11, 12 make it possible advantageously to select and then to detect the light scattered by non-linear optics so as to analyze the non-linear response of the particles placed in solution in the vessel 8 and establish on the basis of this response an electrical signal which is the image of this response toward a computing station 13. This computing station 13 constitutes means for calculating the Hyper-Rayleigh scattering intensity (HRS intensity) of the photons detected by the detection means as a function of each excitation beam E1, E2 and of their polarization and for calculating, for each beam, parameters η_{E1} and η_{E2} representative of the molecular organization within the macromolecules or of the shape of the particles placed in the vessel 8.

The computing station 13 furthermore allows, before carrying out measurements on the tested particles, the establishment of a theoretical diagram η_{E2}=f(η_{E1}) representative of all the geometric configurations and molecular arrangements that are possible within particles or macromolecules.

The establishment of this theoretical diagram η_{E2}=f(η_{E1}) constitutes an essential step of the method of the invention.

This diagram is established in an empirical manner on the basis of the following relations where η_{E1} and η_{E2} are respectively two parameters characteristic of the molecular organization within an assemblage of molecules having a non-linear response, and defined respectively by the following relations:

$$\begin{matrix}{η}_{E 1} = \frac{{a}_{E 1} + {c}_{E 1}}{{b}_{E 1}} and & ( 1 ) \\ {η}_{E 2} = \frac{( {a}_{E 1} - {a}_{E 2} ) + ( {c}_{E 1} - {c}_{E 2} )}{( {b}_{E 1} - {b}_{E 2} )} , & ( 2 )\end{matrix}$$

where a, b, c are the absolute values of the HRS scattering intensity at three distinct angles of polarization of each excitation beam E1, E2 implemented in the method of the invention.

The beams E1, E2 being perpendicular to one another and the detection being done in the direction of incidence of one of the beams (therefore in transmission with respect to the vessel 8), it is possible to calculate for any theoretical configuration the dipolar and quadripolar fractions for each component a, b, c of the following parameters, η_{E1} and η_{E2}, these fractions being defined by the following tensors (for each configuration the values of the tensors are different):

$$\begin{matrix}{a}_{d} = G 〈 {β}_{XXX} β {*}_{XXX} 〉 \\ {b}_{d} = G 〈 4 {β}_{XXX} β {*}_{XXY} + 2 {β}_{XXX} β {*}_{XYY} 〉 \\ {c}_{d} = G 〈 {β}_{XYY} β {*}_{XYY} 〉 \\ {a}_{q} = {G ( Δ k )}^{2} {a}^{2} 〈 [ {Γ}_{L , ZXXX} + {Γ}_{L , YXXX} ] [ Γ {*}_{L , ZXXX} + Γ {*}_{L , YXXX} ] 〉 \\ {b}_{q} = {G ( Δ k )}^{2} {a}^{2} 〈 \begin{matrix}[ {Γ}_{L , ZXXX} + {Γ}_{L , YXXX} ] [ Γ {*}_{L , ZXXX} + Γ {*}_{L , YXXX} ] + \\ [ {Γ}_{L , ZXYY} + {Γ}_{L , YXYY} ] [ Γ {*}_{L , ZXXX} + Γ {*}_{L , YXXX} ] + \\ [ {Γ}_{L , ZXXY} + {Γ}_{L , YXXX} ] [ Γ {*}_{L , ZXYY} + Γ {*}_{L , YXYY} ]\end{matrix} 〉 \\ {c}_{q} = {G ( Δ k )}^{2} {a}^{2} 〈 [ {Γ}_{L , ZXYY} + Γ {*}_{L , YXYY} ] [ Γ {*}_{L , ZXYY} + Γ {*}_{L , YXYY} ] ;\end{matrix}$$

the indices d and q indicating respectively a dipolar and quadripolar component of the HRS intensity values a, b, c for each excitation beam (E1, E2), and with, in these relations:

G which is a constant,

β, Γ two tensors and β*, Γ* their complex conjugate tensors,

(Δk)² the square differential of the wave vectors 2k of the fundamental and of K the wave vector of the harmonic, and

a the size of the particle or macroparticle.

Once the dipolar and quadripolar fractions hereinabove have been calculated, the values of the components a, b, c of the parameters η_{E1} and η_{E2} related to each excitation beam E1, E2 are thereafter determined in accordance with the following relations:

a_{E1}=a_{d}+a_{q} and a_{E2}=a_{d};

b_{E1}=b_{d}+b_{q} and b_{E2}=b_{d};

c_{E1}=c_{d}+c_{q} and c_{E2}=c_{d}.

It is thus possible to determine, for a theoretical geometric configuration of a molecular arrangement or of a shape of particles, corresponding values of parameters η_{E1} and η_{E2}, thereby making it possible to obtain a point on the theoretical graph η_{E2}=f(η_{E1}).

Having nothing a priori on the particular configuration of a given molecular arrangement, the parameters η_{E1} and η_{E2} are thus calculated theoretically for a large number of possible configurations so as to be able to produce the theoretical graph η_{E2}=f(η_{E1}) and thereafter be able, during investigations and measurements on unknown particles, to make the comparison with the values of parameters η_{E1} and η_{E2} calculated on the basis of the experimental measurements of HRS intensities obtained for each of the excitation beams E1, E2.

Accordingly, it suffices to determine the experimental components a, b, c of each parameter η_{E1} and η_{E2} by tagging on the HRS intensity diagrams established for each excitation beam E1, E2 on the basis of measurements on tested particles the values of HRS intensities for three angles of polarization at 0°, 45° and 90°, as represented in FIG. 1, and which are thereafter transferred into relations (1) and (2) presented hereinabove to obtain the value of each experimental parameter η_{E1} and η_{E2}.

It then suffices to transfer these values into the theoretical graph η_{E2}=f(η_{E1}) previously established to determine the spatial configuration or the shape of a tested particle. If the point obtained on the basis of the experimental values of parameters η_{E1} and η_{E2} agrees with a point on the theoretical graph then this means that the tested compound has the same configuration as the theoretically calculated configuration.

The method of the invention can most particularly find an application in fields such as the characterization of opto-electronic and optical hardware items, and then biosensors and biochips.

It may also be highly beneficial in the field of the characterization of small biological particles (proteins) or inorganic ones such as particles of metal, for example from 3 to 150 nm in diameter, where the characterization of the shape is important.

1. A method for determining the spatial configuration of molecules in particles or macromolecules or the shape of metallic particles, according to which:
at least one particle or macromolecule whose molecular organization it is desired to ascertain is placed in solution,
the particle or particles or macromolecules placed in solution is or are excited by way of at least two polarized excitation light beams (E1, E2) propagating and penetrating the solution along two distinct directions of incidence I1, I2,
the photons of light scattered by at least one excited particle or macromolecule present in the solution are detected by non-linear optics;
for each excitation beam (E1, E2), the polarization-resolved Hyper Rayleigh scattering (HRS) intensity of the detected photons of scattered light is determined,
a diagram η_{E2}=f(η_{E1}) is established, where η_{E1} and η_{E2} are respectively two parameters characteristic of the molecular organization within an assemblage of molecules having a non-linear response and defined respectively by the following relations:
$${η}_{E 1} = \frac{{a}_{E 1} + {c}_{E 1}}{{b}_{E 1}} and {η}_{E 2} = \frac{( {a}_{E 1} - {a}_{E 2} ) + ( {c}_{E 1} - {c}_{E 2} )}{( {b}_{E 1} - {b}_{E 2} )} ,$$
where a, b, c are the absolute values of the HRS scattering intensity at three distinct angles of polarization of each excitation beam (E1, E2)
and with:
a_{E1}=a_{d}+a_{q} and a_{E2}=a_{d};
b_{E1}=b_{d}+b_{q} and b_{E2}=b_{d};
c_{E1}=c_{d}+c_{q} and c_{E2}=c_{d};
the indices d and q indicating respectively a dipolar and quadripolar component of the HRS intensity values a, b, c for each excitation beam (E1, E2), these various components being defined by the following mathematical relations:
$$\begin{matrix}{a}_{d} = G 〈 {β}_{XXX} β {*}_{XXX} 〉 \\ {b}_{d} = G 〈 4 {β}_{XXX} β {*}_{XXY} + 2 {β}_{XXX} β {*}_{XYY} 〉 \\ {c}_{d} = G 〈 {β}_{XYY} β {*}_{XYY} 〉 \\ {a}_{q} = {G ( Δ k )}^{2} {a}^{2} 〈 [ {Γ}_{L , ZXXX} + {Γ}_{L , YXXX} ] [ Γ {*}_{L , ZXXX} + Γ {*}_{L , YXXX} ] 〉 \\ {b}_{q} = {G ( Δ k )}^{2} {a}^{2} 〈 \begin{matrix}[ {Γ}_{L , ZXXX} + {Γ}_{L , YXXX} ] [ Γ {*}_{L , ZXXX} + Γ {*}_{L , YXXX} ] + \\ [ {Γ}_{L , ZXYY} + {Γ}_{L , YXYY} ] [ Γ {*}_{L , ZXXX} + Γ {*}_{L , YXXX} ] + \\ [ {Γ}_{L , ZXXY} + {Γ}_{L , YXXX} ] [ Γ {*}_{L , ZXYY} + Γ {*}_{L , YXYY} ]\end{matrix} 〉 \\ {c}_{q} = {G ( Δ k )}^{2} {a}^{2} 〈 [ {Γ}_{L , ZXYY} + Γ {*}_{L , YXYY} ] [ Γ {*}_{L , ZXYY} + Γ {*}_{L , YXYY} ] ;\end{matrix}$$
with:
G which is a constant,
β, Γ two tensors and β*, Γ* their complex conjugate tensors,
(Δk)² the square differential of the wave vectors 2k of the wave vector 2k of the fundamental and of K the wave vector of the harmonic, and
a the size of the particle or macroparticle;
for each previously determined HRS scattering intensity the two parameters η_{E1} and η_{E2} are calculated for the particle or macromolecule under study and
from this is deduced the geometric configuration of the molecules in the particle or macromolecule by transferring these two parameters onto the previously established graph η_{E2}=f(η_{E1}).

2. The method as claimed in claim 1, in which the detection of the photons of light scattered by at least one excited particle or macromolecule in solution is carried out along a direction (D) forming an angle α with the direction of incidence (I1) of a first excitation light beam and forming an angle β with the direction of incidence (I2) of the second excitation light beam in the solution containing the particles or macromolecules under study, α being different from β and greater than zero.

3. The method as claimed in claim 2, in which the directions of incidence (I1) and (I2) of the two excitation light beams are perpendicular to one another.

4. The method as claimed in claim 1, in which the two excitation light beams (E1, E2) are emitted by at least one coherent light source of laser type, in particular a laser of nanosecond or femtosecond type.

5. The method as claimed in claim 1, in which the linear polarization of each excitation light beam is rotated according to at least three distinct angles of polarization during each phase of illuminating and exciting the particles or macromolecules in solution.

6. The method as claimed in claim 2, in which the direction (D) of detection of the photons of light scattered by the particles or macromolecules under study is the same as the direction of incidence (I1, I2) of at least one of the two excitation light beams in the solution containing the particles or macromolecules.

7. A device for the implementation of a method as claimed in claim 1, comprising:
means (1, 5) for producing at least two beams of coherent light (E1, E2),
means (3, 4) for polarizing the at least two beams of coherent light,
at least one vessel or cell (8) able to contain at least one particle or macromolecule placed in solution, the vessel or cell consisting of a material transparent to the two beams of coherent light so as to allow the excitation, by these two beams, of at least one particle or macromolecule in solution placed in the vessel or cell,
means (7) for orienting the two beams of coherent light along two distinct directions of incidence (I1, I2) with respect to the vessel (8) or cell,
means (9, 10, 11, 12) for detecting photons of light scattered by at least one particle or macromolecule in solution present in the vessel or cell and excited by the two beams of coherent light polarized by the polarizing means,
means (13) for calculating the Hyper-Rayleigh scattering intensity (HRS intensity) of the photons detected by the means for detecting and calculating and establishing said so-called diagram η_{E2}=f(η_{E1}).

8. The device as claimed in claim 7, in which the polarizing means comprise at least one polarizer and a half-wave plate.

9. The device as claimed in claim 7, in which the detection means comprise at least one of the following hardware items: photomultiplier; CCD camera; avalanche photodiode.

10. The device as claimed in claim 7, in which the means for producing the two beams of coherent light comprise at least one coherent light source (1) and means (5) for dividing a single beam (2) emitted by this source into two distinct light beams (E1, E2).

11. The device as claimed in claim 7, in which the means for orienting the light beams along two distinct directions of incidence with respect to the vessel or cell (8) comprise reflecting and/or semi-reflecting mirrors (7).

12. The device as claimed in claim 7, in which the vessel or cell (8) consists of a material transparent to the wavelengths λ and λ/2 of the at least two excitation beams (E1, E2).

13. The device as claimed in claim 7, in which the means for producing the two beams of coherent light comprise at least one light source (1) of nanosecond or femtosecond laser type.
